(19) United States
(12) Patent Application Publication
(10) Pub. No.: US 2005/0205329 A1
(43) Pub. Date: Sep. 22, 2005

(54) Vehicle and vehicle drive-through suspension arm

(76) Inventor: Shimon Fanger-Vexler, Santa Clara, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/894,859

(22) Filed: Jul. 20, 2004

Related U.S. Application Data
(60) Provisional application No. 60/547,615, filed on Feb. 25, 2004.

(51) Int. Cl. B60K 17/34

(52) U.S. Cl. 180/234; 280/6.154

(57) ABSTRACT

A vehicle suspension system includes a drive through suspension arm being operably coupled to a motive source and to a ground engaging device for propelling a vehicle and including an internally disposed drive shaft for transmitting rotational torque from the motive source to the ground engaging device and for acting as a resilient torque coupler device acting to provide a spring effect for the ground engaging device. Further, a vehicle includes a motive source and at least one ground engaging device for propelling the vehicle , the motive source being an electric drive that is remotely disposed from the ground engaging device. A method of forming a vehicle is additionally included.

### RELATED APPLICATIONS

The present application claims the benefit of U.S. Provisional Application No. 60/547,615, filed Feb. 25, 2004 and incorporated herein by reference in its entirety.

### TECHNICAL FIELD

The present application relates to vehicles. More particularly, the present application relates to a vehicle drive system and an electric drive vehicle employing the vehicle drive system.

### BACKGROUND OF THE INVENTION

There is a need in the industry for both conventional mechanical vehicle drive systems as well as electric drive systems that may be used in many applications, including future defense programs. To the maximum extent possible, those drive systems should use existing proven components such as wheels, hubs, brakes, and wheel sensors. It is further desirable that potentially vulnerable components of the drive system be always remote from the drive wheel within the armorized vehicle hull in order to maximize longevity in a combat environment.

With respect to electric drive systems, there are existing motor-in-wheel-hub technology, such as Magnet Motor GmbH that couples the electric motor directly to one of the individual wheel-hubs. There are certain disadvantages to this type of technology in that non-standard wheels and hubs must be used in order to accommodate the relatively large size of electric motor residing within the wheel-hub. Additionally, placing the electric motor, which is highly vulnerable, in the wheel-hub tends to make the vehicle employing such a drive system more vulnerable in a combat environment.

Some of the characteristics of a vehicle which directly affect the propulsion are:
reduction of weight and volume of the drive components;
use of platforms having modular components;
high overall efficiency in driving cycles;
energy management and drive-by-wire that maybe remotely controlled;
infinitely variable drive and steering operation; and
multiple sprocket propulsion for tracked vehicles and individual wheel drive for wheeled vehicles.

The advantage of multiple sprocket propulsion for tracked vehicles or individual wheel drive for wheeled vehicles is for improved traction/mobility along with steering capability such as: pivot-steering at zero speed, skid-steering at up to 10 mph, and differential-steering from 10-80 mph on a highway. Additionally, an individually driven wheel provides more options for vehicle recovery in a combat environment. For example, if two of six individually driven wheels are disabled, the remaining four individually driven wheels might readily be used for vehicle recovery.

### SUMMARY OF THE INVENTION

With respect to the more conventional mechanical drive, the major drive components are disposed internal to the vehicle inside the armored hull structure, where they are best protected. The drive through arm of the present invention significantly reduces the un-sprung mass of the suspension by eliminating springs. Additionally, this type of configuration better supports the modularity concept, as tire/wheel-rim sizes can be conventional. Additionally, there is normal space for conventional braking systems in the wheel-rim, including the necessary wheel speed sensors for improved traction/braking and differential steering.

With respect to the electric drive embodiment of the present invention, the electric motors are disposed inboard within the hull structure of the vehicle. In such disposition, the electric motor, as distinct from a motor-in-wheel-hub type technology, is well protected from mud, water and debris. Further, all electric components such as power cables, oil cooling tubes, motors, and motor controllers are well protected behind armor, since they are within the hull structure.

A further advantage of the drive through suspension arm of the present invention is that the connecting shaft of such arm acts as a torque-shaft, providing resilient coupling between the input drive shaft to the suspension arm and the wheel output drive shaft, thereby eliminating the need for suspension springs.

The present invention is a vehicle suspension system including a drive through suspension arm being operably coupled to a motive source and to a ground engaging device for propelling a vehicle and including an internally disposed drive shaft for transmitting rotational torque from the motive source to the ground engaging device and for acting as a resilient torque coupler device acting to provide a spring effect for the ground engaging device. Further, the vehicle includes a motive source and at least one ground engaging device for propelling the vehicle, the motive source being an electric drive that is remotely disposed from the ground engaging device. A method of forming a vehicle is additionally included in the present invention.

### BRIEF DESCRIPTION OF THE DRAWINGS

FIG. 1 is a first embodiment of the present invention depicted in a perspective view of a mechanical drive system disposed in a vehicle, the vehicle being depicted in phantom;

FIG. 2 is a perspective view of the mechanical drive system of FIG. 1 driving a single wheel;

FIG. 3 is a sectional view of the drive through suspension arm housing with the various drive components disposed in the housing;

FIG. 4 is a perspective view of the drive through suspension arm housing with the various drive components disposed within the housing;

FIG. 5 is a perspective view of a second embodiment of the present invention including an electric drive system disposed in a vehicle, the vehicle hall being depicted in phantom;

FIG. 6 is a perspective view of the drive system of the present invention driving a single wheel;

FIG. 7 is a perspective view of a planetary gear set in a wheel hub, the wheel hub depicted in phantom; and

FIG. 8 is a sectional view of the drive through suspension arm and planetary gear set in the wheel hub.

### DETAILED DESCRIPTION OF THE DRAWINGS

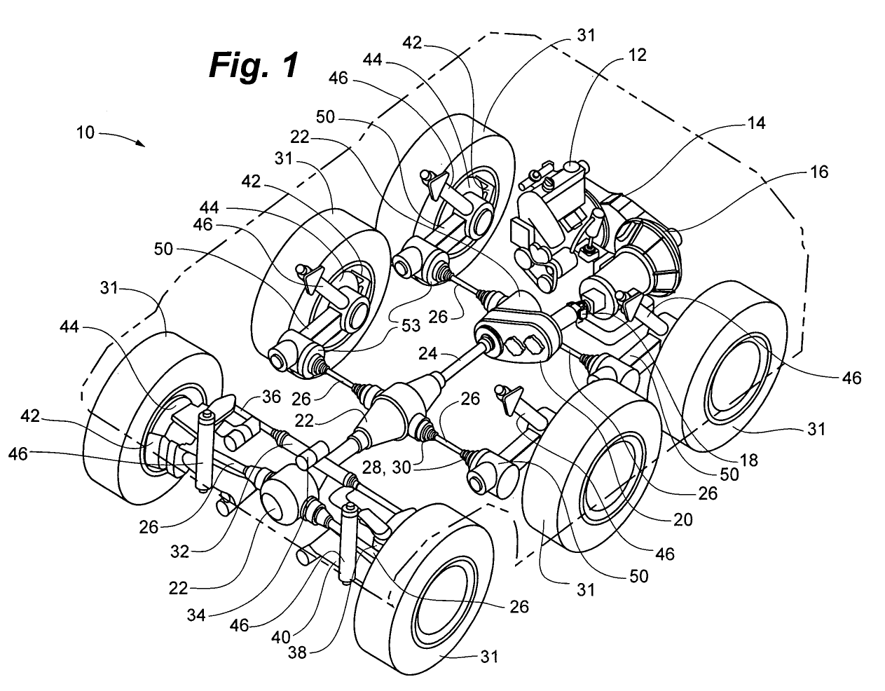

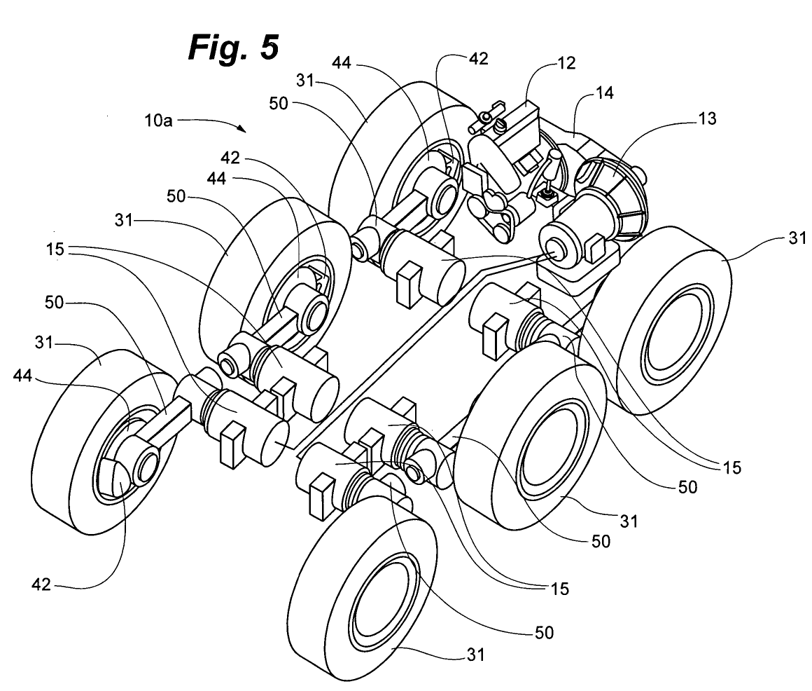

The vehicle of the present invention is generally shown at 10 in FIG. 1 and 10a in FIG. 5. It should be noted that each of the vehicles 10, 10a employ an identical drive through suspension arm 50 that is associated with each wheel 31.

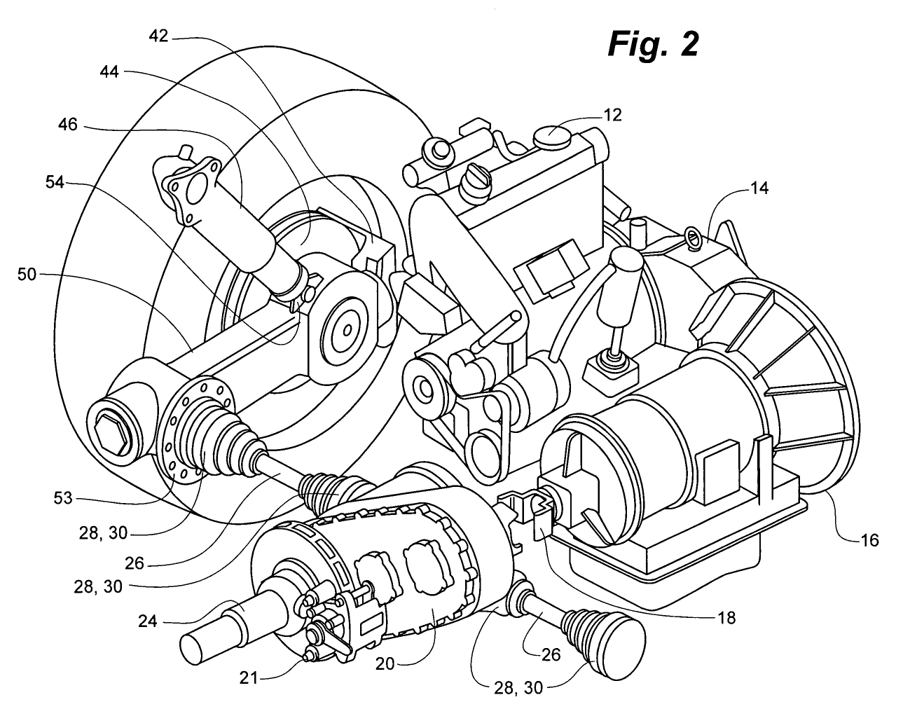

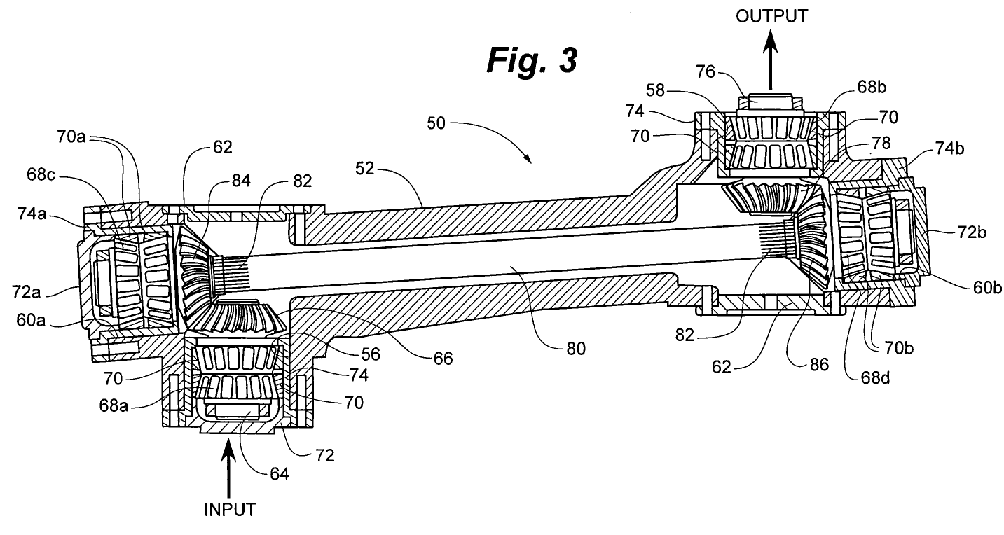

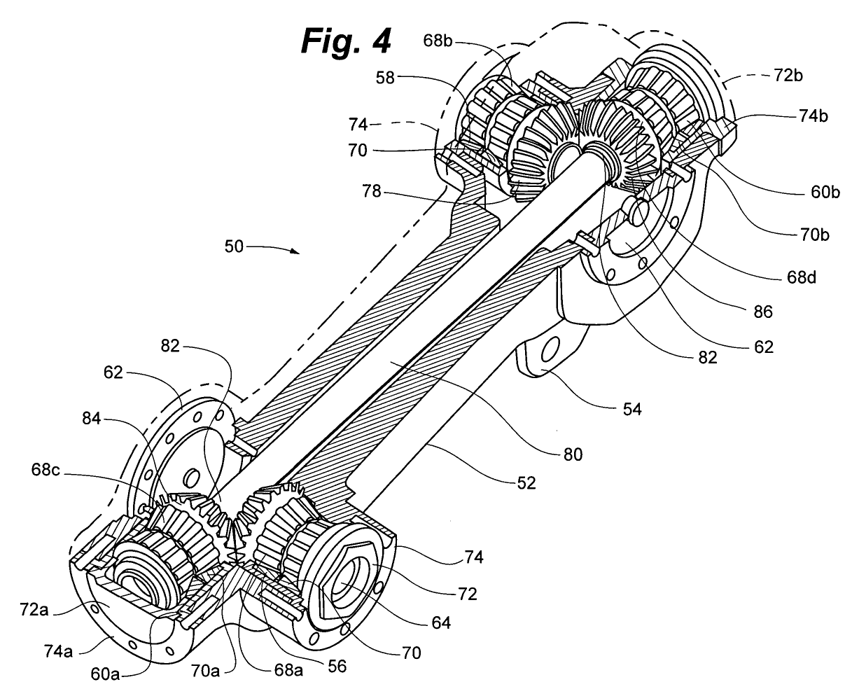

Referring to the embodiment of FIGS. 1-4, the vehicle 10 includes a motive source that may be an internal combustion motor 12. Motor 12 can be any type of internal combustion engine, reciprocating or rotary, employing a number of different hydrocarbon fuels, including both gasoline and diesel as well as others. The motor 12 can also be a fuel cell, although a fuel cell is not technically categorized as an internal combustion engine.

The output of the motor 12 is coupled to an output coupling device 14. The output coupling device 14 may transfer rotational motion and power by means of a belt drive, a chain drive, or a gear set. Other power transfer means may also be incorporated in the output coupling device 14.

The output coupling device 14 is coupled to a transmission 16. The transmission 16 may have a gear and clutch arrangement, a torque converter and gear arrangement, or a variable speed drive, or other means of power transmission. The transmission 16 has a rather short output shaft 18. The output shaft 18 may either be a solid shaft or may employ universal joints or the like. The output shaft 18 is coupled to a transfer case 20. The transfer case 20 may include a parking brake 21, including a disc and caliper. The transfer case 20 is coupled by a plurality of axial drive shafts 24 to a plurality of differentials 22. In this embodiment, each differential 22 provides power to two transversely opposed wheels 31. The differentials 22 could as well service the sprockets of a tracked vehicle. Each differential 22 has a pair of opposed transverse drive shafts 26. The drive shafts 26 preferably include CV joint 28 disposed within a boot 30 at both ends of the transverse drive shaft 26.

The vehicle 10 of FIG. 1 has conventional driven front wheel steering. The two front wheels 31 are powered and accordingly they are connected to the frontmost differential 22 by transverse drive shafts 26. The conventional steering includes a steering mechanism 32 powered by a power steering unit 34. The power steering unit 34 is coupled to a steering arm 36 which is coupled to a rotatable upright 38 for steering the front most wheels 31. The front wheels 31 are each supported on a rotatable A arm 40.

Each of the six wheels 31 of the vehicle 10 include a conventional brake caliper 42, a conventional brake disc 44, and are damped by a conventional shock absorber 46.

The vehicles 10, 10a each include a plurality of drive through suspension arms 50. In these embodiments, a drive through suspension arm 50 is associated with any wheel 31. The drive through suspension arm 50 is coupled by a respective transverse drive shaft 26 to a respective differential 22.

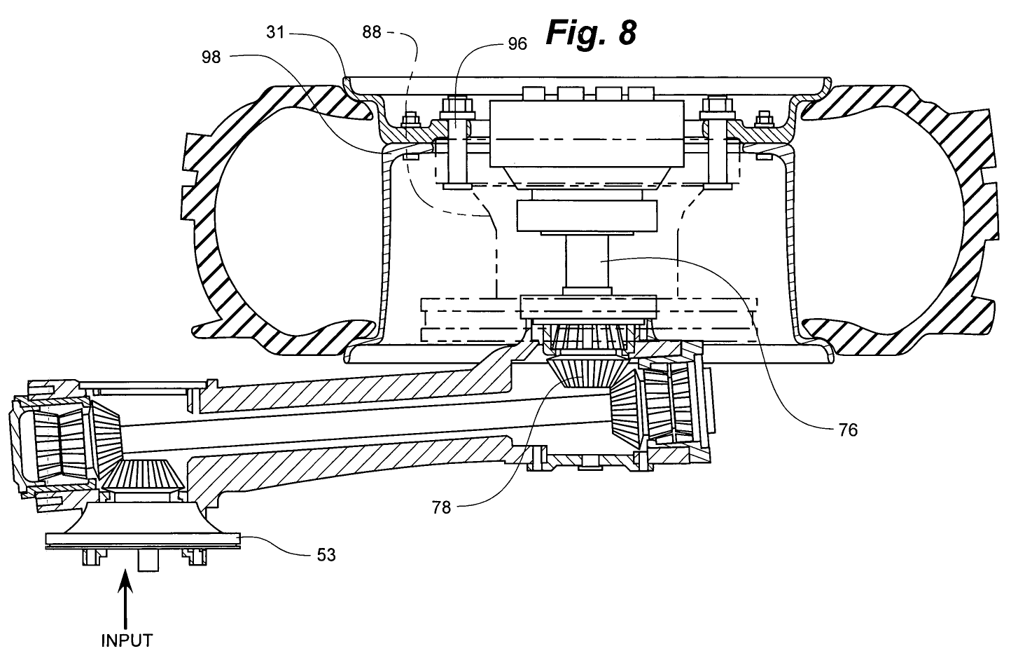

The drive through suspension arm (suspension arm) 50 includes a housing 52. The housing 52 is a generally rectangular center section. A shock absorber mount 54 is formed integral with the housing 52 for mounting a respective shock absorber 46. The suspension arm 50 is rigidly coupled to structure of the vehicle 10 (or of vehicle 10a, as described below) by mounting flange 53. See FIG. 8 also. Housing 52 is free to rotate about mounting flange 53 in order to accommodate up/down motion of the wheel 31 and the suspension arm 50 as a unit, such motion being primarily responsive to changes in the terrain over which the wheel 31 is operated.

An input bearing receiver 56 is formed at a first end of the center section of the housing 52 and an output bearing receiver 58 is formed at a second, opposed end of the center section of the housing 52. Each of the receivers 56, 58 is formed having a cylindrical inner margin.

In addition to the receivers 56, 58, drive shaft bearing receivers 60a, 60b are also formed at respective ends of the housing 52. Cover plates 62 cover openings defined in the housing 52 that are opposed to the respective input bearing receiver 56 and output bearing receiver 58.

A splined input shaft coupling 64 is mated to splines on the respective transverse drive shaft 26 that is coupled to the suspension arm 50. The input shaft coupling 64 terminates at an input spiral bevel gear 66 and is rotatably borne in a two row bearing assembly 68a, 68b.

Suspension arm 50 includes four different bearing assemblies as is noted in more detail below. Each of the bearing assemblies is a two row bearing assembly that is designed to meet heavy duty applications where maximum capacity is required in a limited space.

The first two such bearing assemblies are the input bearing assembly 68a and the output bearing assembly 68b, noted above. Each of the bearing assemblies 68a, 68b includes a bearing race 70 for supporting the two rows of bearings. A retainer 72 abuts the outermost bearing row.

A bearing housing 74 having a cylindrical exterior margin is disposed within the respective input bearing receiver 56 and output bearing receiver 58. The bearing housing 74 is bolted to the housing 52 of the drive through suspension arm 50.

An output shaft coupling 76 is coupled to the hub of the wheel 31 by a short splined shaft. The output shaft coupling 76, is affixed to the output spiral bevel gear 78 and is rotatably supported by the two row bearing assembly 68b.

An elongated drive shaft 80 is disposed within the housing 52 of the suspension arm 50. The drive shaft 80 has a pair of opposed splines 82. The spline 82 at the input end of the drive shaft 80 is coupled to a shaft input spiral bevel gear 84. The shaft input spiral bevel gear 84 is rotatably engaged (meshed) with the input spiral bevel gear 66. The input end of the drive shaft 80 is rotatably borne in the third of the two row bearing assemblies. Bearing assembly 68c includes a bearing race 70a, a retainer 72a, and a bearing housing 74a.

The drive shaft 80 includes a shaft output bevel gear 86 that is coupled by splines 82 to the drive shaft 80. The shaft output spiral bevel gear 86 is rotatably coupled to the output spiral bevel gear 78. The output end of the drive shaft 80 is rotatably borne within two row bearing assembly 68d. The two row bearing assembly 68d includes a bearing race 70b, a retainer 72b, and a bearing housing 74b. The spiral bevel gears 84, 86 are pinion gears.

It should be noted that the drive shaft 80 is connected to the input/output bevel gears 84, 86 through respective splines 82 at both ends of the drive shaft 80. Such coupling transmits pure rotational torque. The drive shaft 80 is mounted to permit a limited axial rotation in order to prevent any bending moment through the shaft. This arrangement is known as a “quill shaft.” The design allows the drive shaft 80 not only to transmit rotational torque, but also to act as a resilient torque coupler device dampening up/down motion of the wheel 31. The drive shaft 80 acts as a torque shaft and also as a resilient torsion coupling device to protect the components of suspension arm 50 from sudden shock on the respective wheel 31 due to operation over rough terrain. The suspension arm 50, by functioning as a transmitter of rotational torque and also as a resilient torque coupler device obviates the need for any spring suspension of the respective wheel 31, significantly simplifying the suspension needs and reducing unsprung weight. In cooperation with the shock absorber 46, the suspension arm 50 provides both the springing effect and the dampening effect for the respective wheel 31.

Turning to the electric drive embodiment of FIGS. 5-8, the vehicle 10a includes a motor 12 coupled to a generator 13 by and output coupling device 14. The generator 13 is electrically coupled to a motive source that may be a plurality of electric motors 15. Other sources of electrical power to the electric motors 15 could be utilized, including batteries and fuel cells. It should be noted that with reference to FIG. 5, that the electric motors 15 are well protected within the hull of the vehicle 10a and behind suitable armor plating. By remotely locating the motors 15 from their respective wheels 31, normal space within the rim of the wheels 31 is provided for conventional braking systems 42, 44. As compared to the wheel-in-hub type electric drive, the embodiment of FIG. 10a is a significant reduction in the unsprung mass of the wheel. Conventional wheel-in-hub electric drives must provide for springing the electric motors, whereas electric motors 15 are fixedly mounted to the chassis of the vehicle 10a. Additionally, the tire/wheel size selection of the vehicle 10a is not related to the motor 15 as it would be in a wheel-in-hub type design. Accordingly, conventional tire/wheel sizes may be employed. This greatly reduces the risk of developing the vehicle 10a by the use of significant existing, proven components.

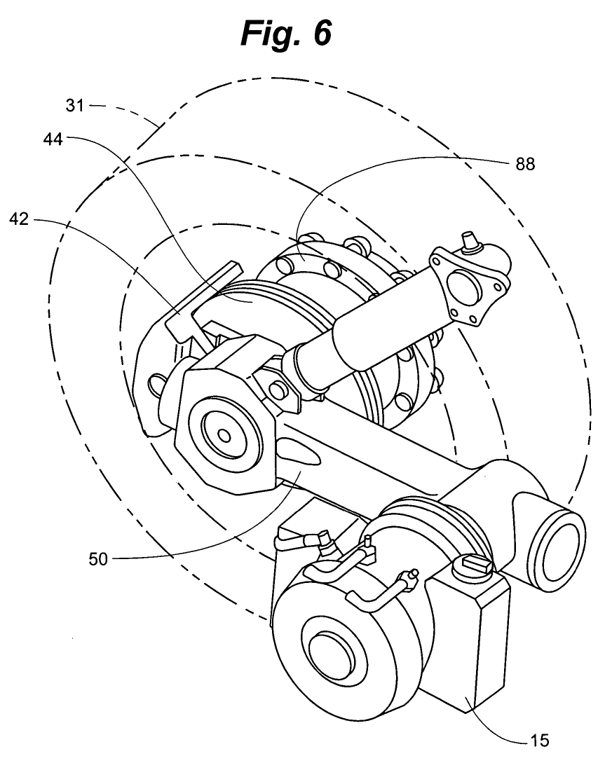

Referring to FIG. 6, an electric motor 15 may be directly coupled to the mounting flange 53 of the suspension arm 50 and is preferably rigidly attached to the structure of the vehicle 10a. As noted above, the suspension arm 50 housing 52 is free to rotated relative to the rigidly attached mounting flange 52.

The output shaft of the electric motor 15 is directly coupled to the input shaft coupling 64 of the suspension arm 50. In all other respects, the suspension arm 50 where used with an electric motor 15 is identical to the suspension arm 50 described above.

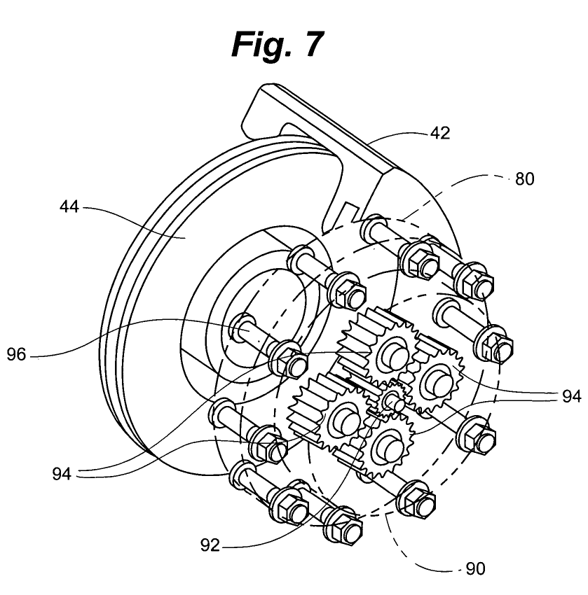

Referring to FIGS. 6 and 7, the hub 88 of the wheel 31 includes a planetary gear set 90 that is directly coupled to the output shaft coupling 76 and output shaft bevel gear 78 of the suspension arm 50. The planetary gear set 90 includes a centrally disposed sun gear 92 surrounded by, in this case, four planetary gears 94. A plurality of lugs and lug bolts 96 are utilized for coupling the hub 88 to the rim 96 of the wheel 31.

In operation, the input torque from the motor 15 or transmission 16 (in the case of conventional drive of the vehicle 10) runs through the suspension arm 50 to drive the individual wheel 31. The suspension arm 50 has independent rotation from the motor 15 around its mounting flange 53. This accommodates relatively small up and down rotation of the suspension arm 50 resulting from terrain condition changes. However, the traction rotation comes from the motor 15/transmission 16 through the drive shaft 80 to constantly provide rotational torque to the wheel 31 through the double gearing of the planetary gear set 90 connected to the drive shaft 80 inside the suspension arm 50.

While a number of presently preferred embodiments of the invention have been illustrated and described, it should be appreciated that the inventive principles can be applied to other embodiments following within the scope of the following claims.

1. A vehicle suspension system, comprising:
a drive through suspension arm being operably coupled to a motive source and to a ground engaging device for propelling a vehicle and including an internally disposed drive shaft for transmitting rotational torque from the motive source to the ground engaging device and for acting as a resilient torque coupler device acting to provide a spring effect for the ground engaging device.

2. The suspension system of claim 1, the drive shaft being mounted to permit a limited amount of axial rotation to prevent bending moment through the drive shaft.

3. The suspension system of claim 1, the drive through suspension arm being rotatable with respect to a rigidly mounted mounting flange for providing a compliant suspension for the ground engaging device over varying terrain conditions.

4. The suspension system of claim 3, the drive through suspension arm including a shock absorber, the suspension arm in cooperation with the shock absorber providing both springing and dampening for the ground engaging device.

5. The suspension system of claim 1, the drive through suspension arm acting to displace the motive source from the ground engaging device.

6. The suspension system of claim 1, the drive shaft having a first and a second spaced apart pinion gears, the pinion gears each being a spiral bevel gear.

7. The suspension system of claim 6, the drive shaft being rotatably supported at a first end and a second end by a respective two row bearing assembly.

8. The suspension system of claim 6, the drive through suspension arm including an input spiral bevel gear in meshed engagement with the first pinion gear.

9. The suspension system of claim 6, the drive through suspension arm including an output spiral bevel gear in meshed engagement with the second pinion gear.

10. The suspension system of claim 8, the drive through suspension arm input spiral bevel gear being rotatably supported by a respective two row bearing assembly.

11. The suspension system of claim 9, the drive through suspension arm output spiral bevel gear being rotatably supported by a respective two row bearing assembly.

12. The suspension system of claim 1, the motive source being an electric drive that is remotely disposed from the ground engaging device.

13. The suspension system of claim 1, the motive source being an electric drive that is displaced from the ground engaging device by the drive through suspension arm.

14. A vehicle, comprising:
a motive source and at least one ground engaging device for propelling the vehicle, the motive source being an electric drive that is remotely disposed from the ground engaging device.

15. The vehicle of claim 14, the motive source being an electric drive that is displaced from the at least one ground engaging device by a drive through suspension arm.

16. The vehicle of claim 15, the drive through suspension arm having an internally disposed drive shaft for transmitting rotational torque from the motive source to the ground engaging device and for acting as a resilient torque coupler device acting to provide a spring effect for the ground engaging device.

17. The vehicle of claim 15, the drive shaft being mounted to permit a limited amount of axial rotation to prevent bending moment through the drive shaft.

18. The vehicle of claim 15, the drive through suspension arm being rotatable with respect to a rigidly mounted mounting flange for providing a compliant suspension for the ground engaging device over varying terrain conditions.

19. The vehicle of claim 18, the drive through suspension arm including a shock absorber, the suspension arm in cooperation with the shock absorber providing both springing and dampening for the ground engaging device.

20. The vehicle of claim 15, the drive shaft having a first pinion gear and a second spaced apart pinion gear, the pinion gears each being a spiral bevel gear.

21. The vehicle of claim 20, the drive shaft being rotatably supported at a first end and at a second end by a respective two row bearing assembly.

22. The vehicle of claim 20, the drive through suspension arm including an input spiral bevel gear in meshed engagement with the first pinion gear.

23. The vehicle of claim 20, the drive through suspension arm including an output spiral bevel gear in meshed engagement with the second pinion gear.

24. The vehicle of claim 22, the drive through suspension arm input spiral bevel gear being roatatably supported by a respective two row bearing assembly.

25. The vehicle of claim 23, the drive through suspension arm output spiral bevel gear being roatatably supported by a respective two row bearing assembly.

26. A method of forming a vehicle having a motive source and at least one ground engaging device for cooperatively propelling the vehicle, the method comprising:
providing the motive source with an electric drive and remotely disposing the electric drive from the at least one ground engaging device.

27. The method of forming the vehicle of claim 26, including displacing the motive source from the at least one ground engaging device by means of a respective drive through suspension arm.

28. The method of forming the vehicle of claim 27, including so disposing an internally disposed drive shaft in the drive through suspension arm for transmitting rotational torque from the motive source to the ground engaging device and for acting as a resilient torque coupler device acting to provide a spring effect for the ground engaging device.

29. The method of forming the vehicle of claim 27, including permitting a limited amount of axial rotation in a drive shaft being mounting for preventing bending moment being transmitted through the drive shaft.

30. The method of forming the vehicle of claim 27, including rotatably coupling the drive through suspension arm to a vehicle structure for providing a compliant suspension for the ground engaging device over rough terrain.

31. The method of forming the vehicle of claim 27, including providing both springing and dampening for the ground engaging device by means of the drive through suspension arm and a shock absorber coupled thereto.

32. The method of forming the vehicle of claim 28, including providing the drive shaft with a first pinion gear and a second spaced apart pinion gear and forming the respective pinion gears as a spiral bevel gear.

33. The method of forming the vehicle of claim 28, including rotatably supporting the drive shaft at a first end and at a second end by respective two row bearing assemblies.

34. The method of forming the vehicle of claim 32, including meshingly engaging a drive through suspension arm input spiral bevel gear with the first pinion gear.

35. The method of forming the vehicle of claim 32, including meshingly engaging a drive through suspension arm output spiral bevel gear with the second pinion gear.

36. The method of forming the vehicle of claim 34, including roatatably supporting the drive through suspension arm input spiral bevel gear by means of a respective two row bearing assembly.

37. The method of forming the vehicle of claim 35, including roatatably supporting the drive through suspension arm output spiral bevel gear by means of a respective two row bearing assembly.
